(19) United States
(12) Patent Application Publication
(10) Pub. No.: US 2016/0329840 A1
(43) Pub. Date: Nov. 10, 2016

(54) ELECTRIC MOTOR WITH BRAKE

(71) Applicant: MITSUBISHI ELECTRIC CORPORATION, Tokyo (JP)

(72) Inventors: Shuichi MORI, Tokyo (JP); Haruyuki HASEGAWA, Tokyo (JP); Toru KATAE, Tokyo (JP)

(73) Assignee: Mitsubishi Electric Corporation, Tokyo (JP)

(21) Appl. No.: 15/108,620

(22) PCT Filed: Mar. 7, 2014
(86) PCT No.: PCT/JP2014/055979

§ 371 Date: Jun. 28, 2016

(51) Int. Cl. H02P 3/22; H02P 15/00; H02K 7/106

(52) U.S. Cl. CPC H02P 3/22; H02K 7/106; H02P 15/00

(57) ABSTRACT

An electric motor with a brake, having a function as a holding brake, includes a brake resistor including three resistors. In a normal state, the brake resistor is such that the three resistors are connected together at ends on one side and at ends on another side and are connected to a brake DC power supply in parallel to each other. In an emergency or an event of an emergency stop, the brake resistor is such that the three resistors are connected together at the ends on one side to form a Y-connection and the ends on another side that are not connected together are electrically connected to the output end of a stator coil of an electric motor or an end having a potential equal to that of the output end.

### FIELD

The present invention relates to an electric motor with a brake.

### BACKGROUND

Rotary electric motors, such as servomotors (hereinafter, simply referred to as electric motors), are often provided with a brake function. The brake is typically used as a holding brake. However, the holding brake sometimes operates as a stopping brake in an emergency or urgent situation.

A typical structure of a holding brake is generally provided with a lining that is configured such that it is fitted to the shaft of the electric motor. With this configuration, when the electric motor is maintained in a stationary state, the holding brake applies a braking force to the lining, and when the electric motor is driven, the braking force acting on the lining is eliminated by using the electromotive force generated by energizing the exciting coil and thereby releasing the braking force.

The braking apparatus described in Patent Literature 1 below discloses a configuration that has a resistor connected such that the electric motor can be short-circuited; a solenoid that applies a pulling force to the brake lever; a charging device that is charged by the power supply used for driving the electric motor and that applies a DC voltage to the solenoid; and the like.

### CITATION LIST

### Patent Literature

Patent Literature 1: Japanese Patent Application Laid-open No. S60-22443

### SUMMARY

### Technical Problem

As described above, with a conventional electric motor with a brake, the holding brake sometimes operates as a stopping brake. If the holding brake operates often as a stopping brake, the life of the lining is shortened due to wear and damage. Accordingly, the lining is changed more frequently, which poses a problem in that the manufacturing cost and the maintenance cost increase.

Wear and damage of the lining itself can be prevented by taking measures, such as providing a protection circuit for delaying the operation of the brake and providing an additional external dynamic brake; however, these measures necessitate provision of an additional device and thus an increase in manufacturing cost and maintenance cost is inevitable.

The present invention has been achieved in view of the above and an object of the present invention is to provide an electric motor with a brake that can prevent a holding brake from operating as a stopping brake and that can effectively achieve a configuration with which an alternative braking force is obtained without increasing the cost.

### Solution to Problem

In order to solve the above problems and achieve the object, an aspect of the present invention is an electric motor with a brake, the electric motor having a function of a holding brake, the electric motor including a brake resistor that includes three resistors, wherein in a normal state, the brake resistor is such that the three resistors are connected together at ends on one side and at ends on another side and are connected to a direct-current power supply in parallel to each other, and in an emergency or in an event of an emergency stop, the brake resistor is such that the three resistors are connected together at the ends on one side to form a Y-connection and the ends on another side that are not connected together are electrically connected to an output end of a stator coil of the electric motor or an end having a potential equal to a potential of the output end.

### Advantageous Effects of Invention

According to the present invention, an effect is obtained where a holding brake can be prevented from operating as a stopping brake and an alternative braking force can be effectively obtained without increasing the cost.

### BRIEF DESCRIPTION OF DRAWINGS

FIG. 1 is a diagram illustrating an exemplary configuration of an electric motor system including an electric motor with a brake according to an embodiment.

FIG. 2 is a circuit diagram of a case where a brake resistor of the electric motor with a brake is operated as a dynamic brake in an emergency.

FIG. 3 is a circuit diagram of a case where the brake resistor of the electric motor with a brake is normally operated.

### DESCRIPTION OF EMBODIMENTS

An electric motor with a brake according to embodiments of the present invention will be explained below with reference to the accompanying drawings. The present invention is not limited to the following embodiments.

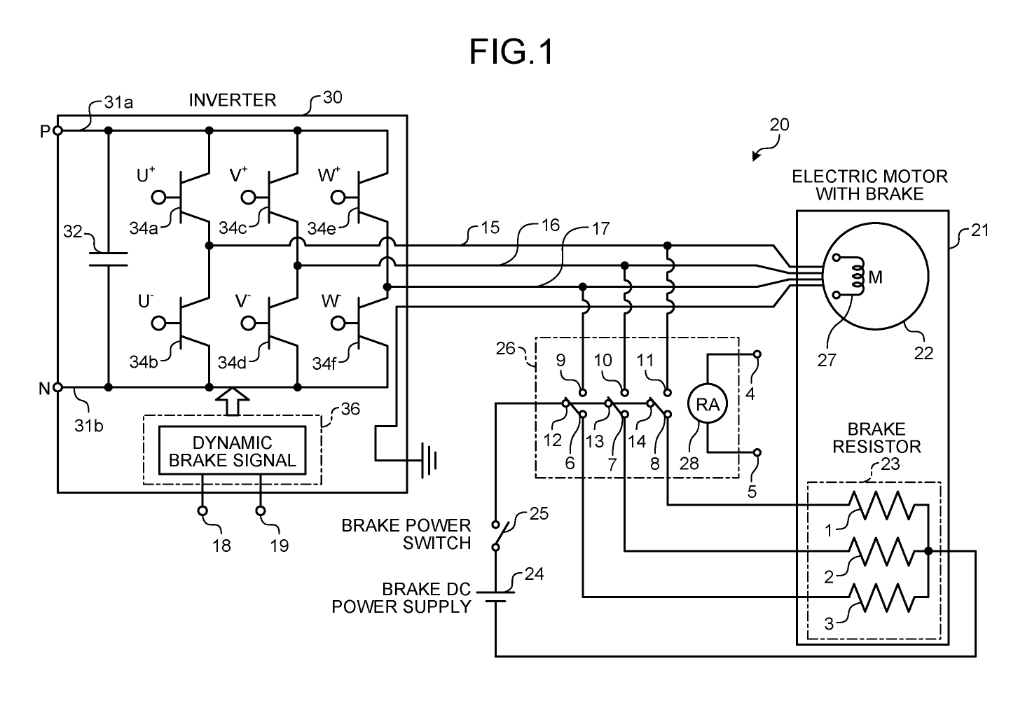

FIG. 1 is a diagram illustrating the configuration of an electric motor system including an electric motor with a brake according to an embodiment. FIG. 1 illustrates one exemplary configuration in a case where the electric motor system is driven by an inverter. As illustrated in FIG. 1, an electric motor system 20 according to the embodiment includes: an electric motor with a brake 21, which includes an electric motor 22 and a brake resistor 23; a brake DC power supply 24; a brake power switch 25; and a relay element 26. The electric motor system 20 is configured such that the electric motor 22 is driven by an inverter 30.

The inverter 30 has a publicly known circuit configuration. Specifically, as illustrated in FIG. 1, a three-phase inverter circuit with UVW phases (U⁺, U⁻, V⁺, V⁻, W⁺, and W⁻) is configured such that a smoothing capacitor 32, which is connected between a high-potential (P potential) side DC line 31a and a low-potential (N potential) side DC line 31b, is connected, a positive-side arm switching element 34a (U⁺) and a negative-side arm switching element 34b (U⁻) are connected in series, and three such series circuits are connected in parallel to each other.

A U-phase AC voltage line 15 is drawn out of the connection point at which the switching element 34a and the switching element 34b are connected. In a similar manner, a V-phase AC voltage line 16 and a W-phase AC voltage line 17 are drawn out of the connection point at which a switching element 34c and a switching element 34d are connected and the connection point at which a switching element 34e and a switching element 34f are connected, respectively. The U-phase AC voltage line 15, the V-phase AC voltage line 16, and the W-phase AC voltage line 17 are connected to the electric motor 22.

The relay element 26 includes common terminals 6, 7, and 8, which are a common terminal (contact) group; relay terminals 9, 10, and 11, which are a switching terminal (contact) group on one side; and relay terminals 12, 13, and 14, which are a switching terminal (contact) group on the other side.

The electric motor with a brake 21 includes the brake resistor 23 in addition to the electric motor 22. The ends on one side of the brake resistor 23 are connected together to be connected to the negative-electrode side of the brake DC power supply 24. The ends on the other side of the brake resistor 23 are not connected together. The brake resistor 23 includes on the other side three resistors 1, 2, and 3, which are connected, respectively, to the common terminals 6, 7, and 8 of the relay element 26. In other words, the three resistors in the brake resistor 23 are Y-connected and the neutral point of the brake resistor 23 is connected to the negative-electrode side of the brake DC power supply 24. It is obvious that the brake resistor 23 may have a connection configuration the opposite way around to that in FIG. 1, i.e., a configuration in which the neutral point of the three resistors is connected to the positive-electrode side of the brake DC power supply 24.

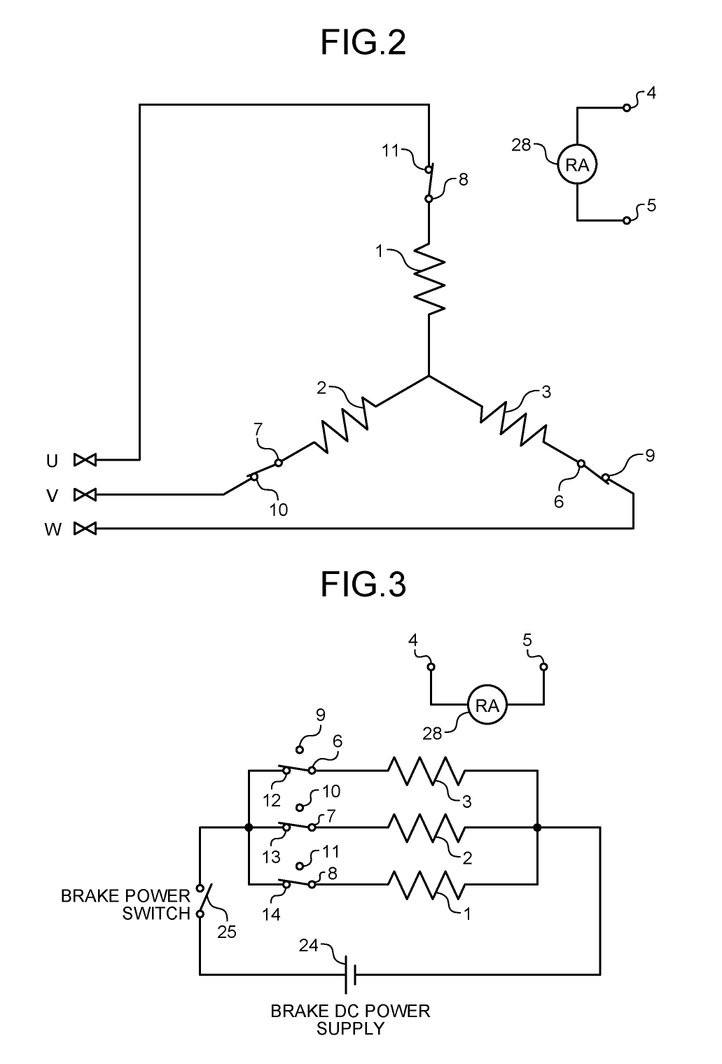

The U-phase AC voltage lines 15, the V-phase AC voltage line 16, and the W-phase AC voltage line 17 are connected to the relay terminals 9, 10, and 11 of the relay element 26, respectively. In the relay element 26, the relay terminals 9, 10, and 11 are closed, whereby a dynamic brake circuit as illustrated also in FIG. 2 is formed.

The relay terminals 12, 13, and 14 of the relay element 26 are electrically connected together so that they have the same potential. The relay terminals 12, 13, and 14 are closed, whereby a brake circuit as illustrated also in FIG. 3 is formed.

Next, an operation of the electric motor with a brake according to the present embodiment will be described with reference to FIG. 1 to FIG. 3.

The inverter 30 drives the electric motor 22 by using the power from the smoothing capacitor 32. A control unit 36 generates control signals for performing PWM (Pulse Width Modulation) modulation on the inverter 30 to control the switching elements 34a to 34f of the inverter 30.

In a normal state, the relay element 26 is switched to the relay terminal 12, 13, and 14 side; therefore, the brake circuit illustrated in FIG. 3 is formed. The brake circuit is operated by controlling the brake power switch 25 such that it is turned on.

In contrast, when such an event occurs that is determined to be an emergency or urgent situation, a dynamic brake signal is, for example, emitted from terminals 18 and 19 of the control unit 36. The dynamic brake signal is input into an exciting coil 28 via signal input terminals 4 and 5 of the relay element 26. Due to the input of the dynamic brake signal, the relay contacts of the relay element 26 are switched to the relay terminal 9, 10, and 11 side; therefore, the circuit configuration becomes such that the resistors 1, 2, and 3 can operate as a dynamic brake.

A characteristic point when a comparison is made between FIG. 2 and FIG. 3 is that, when the brake resistor 23 operates as a dynamic brake, two of the three resistors are connected in series. For example, in FIG. 2, the current that branches off the U-phase AC voltage line 15, flows into the brake resistor 23, and returns to the V-phase AC voltage line 16 passes through the resistors 1 and 2. In a similar manner, the current that branches off the V-phase AC voltage line 16, flows into the brake resistor 23, and returns to the W-phase AC voltage line 17 passes through the resistors 2 and 3; and the current that branches off the W-phase AC voltage line 17, flows into the brake resistor 23, and returns to the U-phase AC voltage line 15 passes through the resistors 1 and 2. Thus, the resistance of the circuit can be increased. Consequently, the amount of heat generated in the resistors can be increased, which enables the rotational energy to be effectively and efficiently consumed.

Another characteristic point is that, when the brake resistor 23 is normally operated, the three resistors 1, 2, and 3 are connected to the brake DC power supply 24 in parallel to each other (see FIG. 3). The three resistors 1, 2, and 3 are connected in parallel to each other; therefore, the current that flows can be three times that of the case where only one resistor is provided, which is efficient and effective. Under the condition where the current flowing to the resistors 1, 2, and 3 from the brake DC power supply 24 is the same, the voltage of the brake DC power supply 24 can be one third.

FIG. 1 illustrates the state where the W-phase AC voltage line 17, the V-phase AC voltage line 16, and the U-phase AC voltage lines 15 are drawn out to be connected to the relay terminals 9, 10, and 11 of the relay element 26; however, because the U-phase AC voltage lines 15, the V-phase AC voltage line 16, and the W-phase AC voltage line 17 are connected to a stator coil 27 of the electric motor 22, the U-phase AC voltage lines 15, the V-phase AC voltage line 16, and the W-phase AC voltage line 17 can be drawn out of the output ends of the stator coil 27 or the ends having a potential equal to that of the output ends.

FIG. 1 exemplifies the configuration in which the relay element 26 is provided outside the electric motor with a brake 21; however, the relay element 26 may be provided in the electric motor with a brake 21. The brake DC power supply 24 and the brake power switch 25 can also be provided in the electric motor with a brake 21.

The relay terminals 9, 10, and 11 of the relay element 26 may be provided in the inverter 30 as long as the relay terminals 9, 10, and 11 can be electrically connected to the W-phase AC voltage line 17, the V-phase AC voltage line 16, and the U-phase AC voltage line 15, respectively. In this case, the brake DC power supply 24 and the brake power switch 25 can also be provided in the inverter 30.

As described above, the electric motor with a brake according to the present embodiment includes a brake resistor that includes three resistors that are connected together at the ends on one side to form a Y-connection. In a normal state, the three resistors are connected together at the ends on one side and at the ends on the other side and they are connected to the brake DC power supply in parallel to each other. In an emergency or in the event of an emergency stop, the ends on the other side that are not connected together are electrically connected to the output ends of the stator coil of the electric motor or the ends having a potential equal to that of the output ends. Therefore, the holding brake can be prevented from operating as a stopping brake and an alternative braking force can be realized without increasing the cost.

Moreover, because the holding brake can be prevented from operating as a stopping brake, wear and damage of the lining of the holding brake can be reduced, which can extend the life of the lining. Therefore, the manufacturing cost and the maintenance cost can be prevented from increasing.

Because the holding brake resistor can be operated as a dynamic brake, it is not necessary to additionally provide an external dynamic brake resistor, which can prevent the manufacturing cost and the maintenance cost from increasing and the size of the system from increasing.

The configuration described in the embodiment described above is only an example of the configuration of the present invention. It is obvious that it can be combined with other well-known technologies and can be modified without departing from the scope of the invention, such as omitting a part of the configuration.

### INDUSTRIAL APPLICABILITY

As described above, the electric motor with a brake according to the present invention is useful as an invention that can prevent a holding brake from operating as a stopping brake and that can effectively achieve a configuration with which an alternative braking force is obtained without increasing the cost.

### REFERENCE SIGNS LIST

1, 2, 3 resistor, 4, 5 signal input terminal, 6, 7, 8 common terminal, 9 to 14 relay terminal, 15 U-phase AC voltage line, 16 V-phase AC voltage line, 17 W-phase AC voltage line, 18, 19 terminal, 20 electric motor system, 21 electric motor with a brake, 22 electric motor, brake resistor, 24 brake DC power supply, 25 brake power switch, 26 relay element, 27 stator coil, 28 exciting coil, 30 inverter, 31a high-potential side DC line, 31b low-potential side DC line, 32 smoothing capacitor, 34a to 34f switching element, 36 control unit.

1. An electric motor with a brake, the electric motor having a function of a holding brake, the electric motor comprising
a brake resistor that includes three resistors, wherein
in a normal state, the brake resistor is such that the three resistors are connected together at ends on one side and at ends on another side and are connected to a direct-current power supply in parallel to each other, and
in an emergency or in an event of an emergency stop, the brake resistor is such that the three resistors are connected together at the ends on one side to form a Y-connection and the ends on another side that are not connected together are electrically connected to output ends of a stator coil of the electric motor, respectively, so as to form pairs.

2. The electric motor with a brake according to claim 1, wherein the brake resistor functions as a dynamic brake in an emergency or in an event of an emergency stop.

3. The electric motor with a brake according to claim 1, further comprising a relay element that includes an exciting coil, wherein
the exciting coil is operated by a dynamic brake signal, and
the relay element switches a connection of the three resistors in the brake resistor in accordance with the dynamic brake signal.

4. The electric motor with a brake according to claim 3, wherein the relay element is incorporated in the electric motor with a brake.
